(19) United States
(12) Patent Application Publication
(10) Pub. No.: US 2026/0274319 A1
(43) Pub. Date: Sep. 17, 2026

(54) Shopping Cart with Forward-Positioned Rear Wheels

(71) Applicant: Maplebear Inc., San Francisco, CA (US)

(72) Inventors: Weiting Chen, Shanghai (CN); Linhua Luo, Shanhai (CN); YanYing Tai, Shanghai (CN)

(21) Appl. No.: 19/242,650

(22) Filed: Jun. 18, 2025

Related U.S. Application Data
(63) Continuation-in-part of application No. PCT/CN2025/083015, filed on Mar. 17, 2025.

(51) Int. Cl. B62B 3/14

(52) U.S. Cl. CPC B62B 3/1492; B62B 3/1424; B62B 2301/044; B62B 2301/08

(57) ABSTRACT

A smart shopping cart includes a pair of front wheels and a pair of forward-positioned rear wheels. The front wheels are swivel wheels and the rear wheels are fixed wheels. The rear wheels are forward positioned in that the rear wheels are positioned substantially in front of the handlebars of the smart shopping cart. For example, whereas the rear wheels of traditional shopping carts are generally close to or to the rear of the handlebars of the shopping cart, the rear wheels of the described smart shopping cart are substantially in front of the handlebars. By moving the rear wheels closer to the center of mass of the smart shopping cart, the smart shopping cart becomes easier to turn relative to traditional shopping carts.

### CROSS REFERENCE TO RELATED APPLICATIONS

This application is a bypass continuation-in-part of PCT Patent Application Serial No. PCT/CN2025/083015, filed Mar. 17, 2025, which is incorporated by reference herein in its entirety.

### BACKGROUND

Traditional shopping carts are designed with rear wheels that are positioned in line with or behind the handlebars. This positioning of the rear wheels means that the rear wheels are further from the center of mass of the traditional shopping cart, which reduces or eliminates the chance that a user will cause the cart to tip by pressing downwards (e.g., leaning) on the handlebars.

However, this design has drawbacks. For example, since the rear wheels are generally fixed and thus provide the axis of rotation for turning the cart, the handlebars are closely positioned to the turning axis of rotation. This means that a user must impart a relatively high turning force to the handlebars to turn the cart. This drawback is generally an acceptable exchange though for conventional shopping carts, which are relatively lightweight and thus easy to maneuver.

However, with the advent of smart shopping carts, which incorporate significant additional hardware, the weight of the cart has increased substantially. Smart shopping carts are equipped with various technological components to enhance the shopping experience. These components include cameras for capturing image data, load sensors for measuring the weight of items, proximity sensors for detecting the addition of items, computing systems for automated checkout processes, and a battery for powering the smart shopping cart. While these features provide numerous benefits, they also contribute to the overall mass of the cart, making it heavier and more challenging to maneuver.

When the mass of the cart is higher, the effort required to turn the cart increases significantly. This can lead to difficulties in navigating aisles, especially in crowded or narrow spaces. The increased weight and the positioning of the rear wheels make it harder for users to control the cart, resulting in a less efficient and more cumbersome shopping experience.

### SUMMARY

A smart shopping cart includes a pair of front wheels and a pair of forward-positioned rear wheels (“rear wheels”). The front wheels are swivel wheels and the rear wheels are fixed wheels. The rear wheels are forward positioned in that they are positioned substantially in front of the handlebars of the smart shopping cart. For example, whereas the rear wheels of traditional shopping carts are generally close to or to the rear of the handlebars of the shopping cart, the rear wheels of the described smart shopping cart are substantially in front of the handlebars. For example, the distance of the center of the rear wheels to the handlebars may be 240 mm to 300 mm, and preferably 270 mm. As another example, the distance between the rear wheels and the front-to-rear center of mass may be 150 mm to 210 mm, and preferably 180 mm.

By moving the rear wheels closer to the center of mass of the smart shopping cart, the smart shopping cart actually becomes easier to turn relative to traditional (i.e., not-smart) shopping carts and/or other smart shopping carts. For example, as described in further detail below with regards to Table I, experiments demonstrated the turning forces required to maneuver a conventional shopping cart with the traditional rear-wheel arrangement were, on average, about 5% higher than the turning forces for a smart shopping cart with a rear-wheel configuration according to the embodiment illustrated in FIG. 2. This reduced turning force was measured despite the additional mass of the smart shopping cart. Thus, the rear-wheel configuration described herein provides unexpected benefits relative to prior art shopping cart configurations.

### BRIEF DESCRIPTION OF THE DRAWINGS

FIG. 1 illustrates an example system environment for a smart cart system, in accordance with one or more embodiments.

FIG. 2 is a first side view of an example embodiment of a smart shopping cart with a forward-positioned rear wheel, in accordance with one or more embodiments.

FIG. 3 is a zoomed-in view of wheels of a smart shopping cart, in accordance with one or more embodiments.

FIG. 4 is a second side view of an example embodiment of a smart shopping cart with a forward-positioned rear wheel, in accordance with one or more embodiments.

FIG. 5 is a first perspective view of an example embodiment of a smart shopping cart with a forward-positioned rear wheel, in accordance with one or more embodiments.

FIG. 6 is a second perspective view of an example embodiment of a smart shopping cart with a forward-positioned rear wheel, in accordance with one or more embodiments.

FIG. 7 is a front view of an example embodiment of a smart shopping cart with a forward-positioned rear wheel, in accordance with one or more embodiments.

FIG. 8 is a rear view of an example embodiment of a smart shopping cart with a forward-positioned rear wheel, in accordance with one or more embodiments.

FIG. 9 is a top-down view of an example embodiment of a smart shopping cart with a forward-positioned rear wheel, in accordance with one or more embodiments.

FIG. 10 is a bottom-up view of an example embodiment of a smart shopping cart with a forward-positioned rear wheel, in accordance with one or more embodiments.

### DETAILED DESCRIPTION

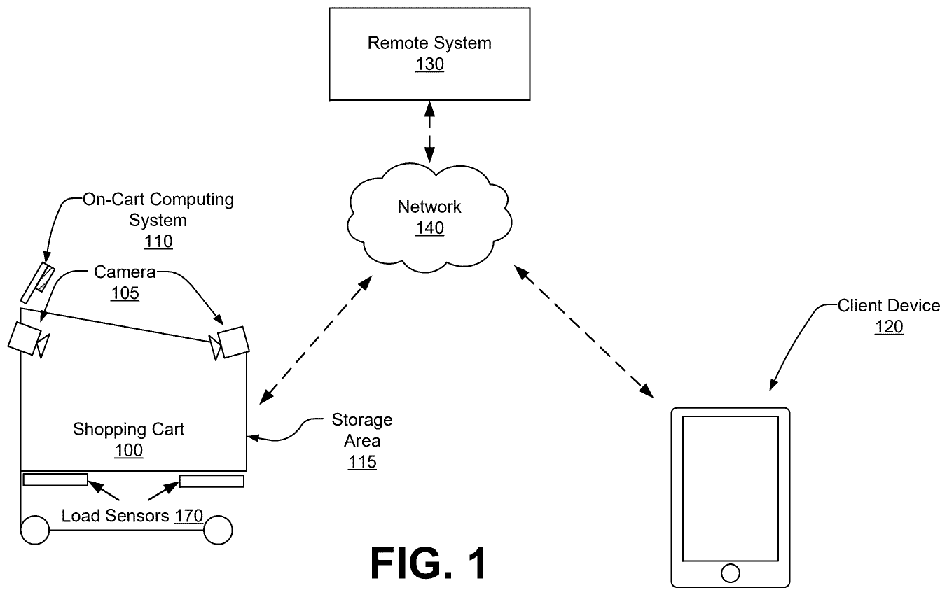

FIG. 1 illustrates an example system environment for a smart cart system, in accordance with one or more embodiments. The system environment illustrated in FIG. 1 includes a shopping cart 100, a client device 120, a remote system 130, and a network 140. Alternative embodiments may include more, fewer, or different components from those illustrated in FIG. 1, and the functionality of each component may be divided between the components differently from the description below. For example, functionality described below as being performed by the shopping cart may be performed, in some embodiments, by the remote system 130 or the client device 120. Similarly, functionality described below as being performed by the remote system 130 may, in some embodiments, be performed by the shopping cart 100 or the client device 120. Additionally, each component may perform their respective functionalities in response to a request from a human, or automatically without human intervention.

A shopping cart 100 is a vessel that a user can use to hold items as the user travels through a source location (e.g., store). The shopping cart 100 includes one or more cameras 105 that capture image data of the shopping cart's storage area and a user interface that the user can use to interact with the shopping cart 100. The shopping cart 100 may include additional components not pictured in FIG. 1, such as processors, computer-readable media, power sources (e.g., batteries), network adapters, or sensors (e.g., load sensors, thermometers, proximity sensors).

The cameras 105 capture image data of the shopping cart's storage area. The cameras 105 may capture two-dimensional or three-dimensional images of the shopping cart's contents. The cameras 105 are coupled to the shopping cart 100 such that the cameras 105 capture image data of the storage area from different perspectives. Thus, items in the shopping cart 100 are less likely to be overlapping in all camera perspectives. In one or more embodiments, the cameras 105 include embedded processing capabilities to process image data captured by the cameras 105. For example, the cameras 105 may be mobile industry processor interface (MIPI) cameras. The cameras 105 may be set to capture images from the area surrounding the shopping cart 100 including the user of the shopping cart 100. In one or more embodiments, at least one of the cameras 105 is directed outward, away from the shopping cart 100.

In one or more embodiments, the shopping cart 100 captures image data in response to detecting that an item is being added to a storage area 115 of the shopping cart 100. The storage area 115 may be a shopping basket, a receptacle, or some other object with a partial enclosure that can be used to receive and store shopping items. The shopping cart 100 may detect that an item is being added to the storage area 115 based on sensor data from sensors on the shopping cart 100. For example, the shopping cart 100 may detect that a new item has been added when the shopping cart 100 (e.g., load sensors 170) detects a change in the overall weight of the contents of the storage area 115 based on load data from load sensors. Similarly, the shopping cart 100 may detect that a new item is being added based on proximity data from proximity sensors indicating that something is approaching the storage area of the shopping cart 100. The shopping cart 100 may capture image data within a timeframe near when the shopping cart 100 detects a new item. For example, the shopping cart 100 may activate the cameras 105 and store image data in response to detecting that an item is being added to the shopping cart 100 and for some period of time after that detection.

The shopping cart 100 may include one or more sensors that capture measurements describing the shopping cart 100, items in the shopping cart's storage area, or the area around the shopping cart 100. For example, the shopping cart 100 may include load sensors 170 that measure the weight of items placed in the storage area 115. Load sensors 170 are further described below. Similarly, the shopping cart 100 may include proximity sensors that capture measurements for detecting when an item is added to the shopping cart 100. The shopping cart 100 may transmit data from the one or more sensors to the remote system 130.

The one or more load sensors 170 capture load data for the shopping cart 100. In one or more embodiments, the one or more load sensors 170 are scales that detect the weight (e.g., the load) of the content in the storage area 115 of the shopping cart 100. The load sensors 170 can also capture load curves—the load signal produced over time as an item is added to the shopping cart 100 or removed from the shopping cart 100. The load sensors 170 may be attached to the shopping cart 100 in various locations to pick up different signals that may be related to items added at different positions of the storage area 115. For example, a shopping cart 100 may include a load sensor 170 at each of the four corners of the bottom of the storage area 115. In one or more embodiments, the load sensors 170 record load data continuously while the shopping cart 100 is in use. In one or more other embodiments, the shopping cart 100 includes some triggering mechanism, for example a light sensor, an accelerometer, or another sensor to determine that the user is about to add an item to the shopping cart 100 or about to remove an item from the shopping cart 100. The triggering mechanism may cause the load sensors 170 to begin recording load data for some period of time, for example a preset time range.

The shopping cart 100 may include one or more wheel sensors (not shown) that measure wheel motion data of the one or more wheels. The wheel sensors may be coupled to one or more of the wheels on the shopping cart 100. In one or more embodiments, a shopping cart 100 includes at least two wheels (e.g., four wheels in the majority of shopping carts) with two wheel sensors coupled to two wheels. In further embodiments, the two wheels coupled to the wheel sensors can rotate about an axis parallel to the ground and can orient about an axis orthogonal or perpendicular to the ground. In one or more embodiments, each of the wheels on the shopping cart has a wheel sensor (e.g., four wheel sensors coupled to four wheels). The wheel motion data includes at least rotation of the one or more wheels (e.g., information specifying one or more attributes of the rotation of the one or more wheels). Rotation may be measured as a rotational position, rotational velocity, rotational acceleration, some other measure of rotation, or some combination thereof. Rotation for a wheel is generally measured along an axis parallel to the ground. The wheel rotation may further include orientation of the one or more wheels. Orientation may be measured as an angle along an axis orthogonal or perpendicular to the ground. For example, the wheels are at 0° when the shopping cart 100 is moving straight and forward along an axis running through the front and the back of the shopping cart 100. Each wheel sensor may be a rotary encoder, a magnetometer with a magnet coupled to the wheel, an imaging device for capturing one or more features on the wheel, some other type of sensor capable of measuring wheel motion data, or some combination thereof.

The shopping cart 100 includes an on-cart computing system 110 that enables the user to perform an automated checkout through the shopping cart 100. The computing system 110 includes a processor and a non-transitory computer-readable medium that stores instructions that may be executed by the processor. The computing system 110 also may include a display, a speaker, a microphone, a keypad, or a payment system (e.g., a credit card reader). The computing system 110 also includes a wireless network adapter that allows the computing system to communicate via the network 140.

The on-cart computing system 110 allows a customer at a source location (e.g., brick-and-mortar store) to complete a checkout process in which items are scanned and paid for without having to go through a human cashier at a point-of-sale station. The on-cart computing system 110 receives data describing a user's shopping trip in a source location and generates a shopping list based on items that the user has selected. For example, the on-cart computing system 110 may receive data from cameras or sensors coupled to the shopping cart 100 and may determine, based on the data, which items the user has added to their cart.

The on-cart computing system 110 may use machine-learning models or computer-vision techniques to identify items that the user adds to the shopping cart 100. For example, the on-cart computing system 110 may apply a barcode detection model to images captured by a camera of the shopping cart 100 to identify items based on the barcodes that are visible to the camera. The barcode detection model is a machine-learning model (e.g., a neural network) that is trained to identify item identifiers that are encoded in barcodes that are depicted in image data. The barcode detection model may be trained based on a set of training examples. Each of the training examples may include an image of a barcode and a label that indicates what item identifier encoded by the barcode. In some embodiments, the on-cart computing system 110 preprocesses the image before applying the barcode detection model to the image. For example, the on-cart computing system may rotate the image so that the barcode is aligned with a set direction or may crop an image of an item to a portion of the image that depicts the barcode. U.S. patent application Ser. No. 17/703,076, entitled “Image-Based Barcode Decoding” and filed Mar. 24, 2022, describes an example barcode detection model in accordance with some embodiments and is incorporated by reference.

The on-cart computing system 110 also may store and apply an optical character recognition (OCR) model to the image. An OCR model is a machine-learning model that converts typed, handwritten, or printed text depicted in images into machine-readable text. The on-cart computing system applies the OCR model to images captured by the cameras to identify items depicted in those images. For example, the on-cart computing system 110 may generate a set of OCR text for an image. This OCR text is text that the OCR model has identified as being depicted in the image. The on-cart computing system 110 uses the OCR text to identify items in images. For example, the on-cart computing system 110 may apply another machine-learning model (e.g., a large language model) to the OCR text to predict which item is depicted in the image based on the OCR text.

In one or more embodiments, the on-cart computing system 110 uses an item lookup table to identify items depicted in an image based on OCR text extracted from that image. The item lookup table stores a set of items that may be depicted in images captured by the cameras and corresponding text that is associated with each of the items. The on-cart computing system 110 stores the item lookup table for use in identifying items. For example, the on-cart computing system 110 may compare OCR text from an image to the corresponding text for each of the items to identify items depicted in images. The on-cart computing system 110 may identify the item by identifying which item in the item lookup table has the most characters or words in common with the OCR text or which item has the longest sequence of characters in common with the OCR text. In one or more embodiments, rather than storing text in the item lookup table, the item lookup table stores embeddings that represent text associated with items. In such cases, the on-cart computing system 110 may generate an embedding for OCR text and compare that embedding to the embeddings stored in the item lookup table to identify the item.

Furthermore, the on-cart computing system 110 may store and apply an image embedding model to captured images to identify items. The image embedding model is a machine-learning model that is trained to generate embeddings for images captured by the cameras. The on-cart computing system 110 applies the image embedding model to images captured by the cameras of the shopping cart and uses the embeddings to identify which items are depicted in the images. For example, the on-cart computing system 110 may store embeddings that correspond to items that a user may place in the shopping cart 100. Each item may be associated with a single embedding or multiple embeddings. The on-cart computing system 110 applies the image embedding model to images captured by the cameras and compares the generated embeddings to stored embeddings for items. The on-cart computing system 110 identifies which item or items are depicted in an image based on how similar the generated embeddings are to the stored embeddings corresponding to the item(s). For example, the on-cart computing system 110 may compute a distance, dot product, or cosine similarity between the embeddings to identify the item in the images. U.S. patent application Ser. No. 17/726,385, entitled “System for Item Recognition using Computer Vision” and filed Apr. 21, 2022, describes example methodologies for identifying items using a machine-learning model and is incorporated by reference.

Any of these models may be sensor fusion models that take sensor data as additional inputs. For example, a model may use weight data from a load sensor or proximity data from a proximity sensor as an additional input to predict an identifier for an item added to the shopping cart 100.

The on-cart computing system 110 generates a shopping list for the user as the user adds items to the shopping cart 100. The shopping list is a list of items that the user has gathered in the storage area 115 of the shopping cart 100 and intends to purchase. The shopping list may include identifiers for the items that the user has gathered (e.g., stock keeping units (SKUs)) and a quantity for each item. When the user indicates that they are done shopping at the source location, the on-cart computing system 110 interfaces with the remote system 130 to facilitate a transaction between the user and the source location for the user to purchase their selected items. For example, the on-cart computing system 110 may receive payment information from the user through a user interface and transmit that payment information to the remote system 130.

The user interface of the on-cart computing system 110 may allow the user to adjust the items in their shopping list or to provide payment information for a checkout process. Additionally, the user interface may display a map of the source location indicating where items are located within the source location. In one or more embodiments, a user may interact with the user interface to search for items within the source location, and the user interface may provide a real-time navigation interface for the user to travel from their current location to an item within the source location. The user interface also may display additional content to a user, such as suggested recipes or items for purchase. In one or more embodiments, the on-cart computing system 110 may receive content from the remote system 130 to display to the user. For example, the on-cart computing system 110 may receive item recommendations, recipe recommendations, or brand recommendations from the remote system 130.

The on-cart computing system 110 may include a tracking system configured to track a position, an orientation, movement, or some combination thereof of the shopping cart 100 in an indoor environment. The tracking system may further include other sensors capable of capturing data useful for determining position, orientation, movement, or some combination thereof of the shopping cart 100. Other example sensors include, but are not limited to, an accelerometer, a gyroscope, etc. The tracking system may provide real-time location of the shopping cart 100 to an online system and/or database. The location of the shopping cart 100 may inform content to be displayed by the user interface. For example, if the shopping cart 100 is located in one aisle, the display can provide navigational instructions to a user to navigate them to a product in the aisle. In other example use cases, the display can provide suggested products or items located in the aisle based on the user's location.

A user can also interact with the shopping cart 100 or the remote system 130 through a client device 120. The client device 120 can be a personal or mobile computing device, such as a smartphone, a tablet, a laptop computer, or desktop computer. In one or more embodiments, the client device 120 executes a client application that uses an application programming interface (API) to communicate with the remote system 130 through the network 140. The client device 120 may allow the user to add items to a shopping list and to checkout through the remote system 130. For example, the user may use the client device 120 to capture image data of items that the user is selecting for purchase, and the client device 120 may provide the image data to the remote system 130 to identify the items that the user is selecting. The client device 120 may adjust the user's shopping list based on the identified item. In some embodiments, the user can also manually adjust their shopping list through the client device 120.

In one or more embodiments, the on-cart computing system 110, the camera(s), and the sensors of the shopping cart 100 are separately mounted to the shopping cart 100. Alternatively, the on-cart computing system 110, camera(s), and sensors may be contained within a single casing that is mounted to the shopping cart 100. This single casing may contain all of the components needed by the on-cart computing system 110 to perform the functionalities described herein. The single casing may be permanently mounted to the shopping cart 100 or may be configured to be easily attached to or detached from the shopping cart 100. This latter embodiment may enable the on-cart computing system 110 to be recharged at a separate station from the shopping cart 100 or may allow the computing system 110 to be easily mounted to pre-existing shopping carts, rather than requiring specially built shopping carts.

The shopping cart 100 and client device 120 can communicate with the remote system 130 via a network 140. The network 140 is a collection of computing devices that communicate via wired or wireless connections. The network 140 may include one or more local area networks (LANs) or one or more wide area networks (WANs). The network 140, as referred to herein, is an inclusive term that may refer to any or all of standard layers used to describe a physical or virtual network, such as the physical layer, the data link layer, the network layer, the transport layer, the session layer, the presentation layer, and the application layer. The network 140 may include physical media for communicating data from one computing device to another computing device, such as MPLS lines, fiber optic cables, cellular connections (e.g., 3G, 4G, or 5G spectra), or satellites. The network 140 also may use networking protocols, such as TCP/IP, HTTP, SSH, SMS, or FTP, to transmit data between computing devices. In one or more embodiments, the network 140 includes Bluetooth or near-field communication (NFC) technologies or protocols for local communications between computing devices. The network 140 may transmit encrypted or unencrypted data.

The remote system 130 communicates with the on-cart computing system 110 of the shopping cart 100 to provide an automated checkout experience for the user. The remote system 130 may facilitate the user's payment for the items in the shopping cart 100. For example, the remote system 130 may receive the user's shopping list from the shopping cart 100 and charge the user for the cost of the items in the shopping cart 100. The remote system 130 may communicate with other systems to execute the transaction, such as a computing system of the source (e.g., retailer) or of a financial institution. The remote system 130 may receive payment information from the shopping cart 100 and uses that payment information to charge the user for the items. Alternatively, the remote system 130 may store payment information for the user in user data describing characteristics of the user. The remote system 130 may use the stored payment information as default payment information for the user and charge the user for the cost of the items based on that stored payment information.

In one or more embodiments, the remote system 130 establishes a session for a user to associate the user's actions with the shopping cart 100 to that user. The user may establish the session by inputting a user identifier (e.g., phone number, email address, username, etc.) into a user interface of the remote system 130. The user also may establish the session through the client device 120. The user may use a client application operating on the client device 120 to associate the shopping cart 100 with the client device 120. The user may establish the session by inputting a cart identifier for the shopping cart 100 through the client application, e.g., by manually typing an identifier or by scanning a barcode or QR code on the shopping cart 100 using the client device 120. In one or more embodiments, the remote system 130 establishes a session between a user and a shopping cart 100 automatically based on sensor data from the shopping cart 100 or the client device 120. For example, the remote system 130 may determine that the client device 120 and the shopping cart 100 are in proximity to one another for an extended period of time, and thus may determine that the user associated with the client device 120 is using the shopping cart 100.

The remote system 130 may also provide content to the on-cart computing system 110 to display to the user while the user is operating the shopping cart 100. For example, the remote system 130 may use stored user data associated with the user of the shopping cart 100 to select content that the user is most likely to interact with. The remote system 130 may transmit that content to the on-cart computing system 110 for display to the user. The remote system 130 may also provide other data to the on-cart computing system 110. For example, the remote system 130 may store item data describing items in the source location and the remote system 130 may provide that item data to the on-cart computing system 110 for the on-cart computing system 110 to use to identify items.

In one or more embodiments, a user who interacts with the shopping cart 100 or the client device 120 may be an individual shopping for themselves or a shopper for an online system. The shopper is a user who collects items from a source location on behalf of a user of the online system. For example, a user may submit a list of items that they would like to purchase. The online system may transmit that list to a shopping cart 100 or a client device 120 used by a shopper. The shopper may use the shopping cart 100 or the client device 120 to add items to the user's shopping list. When the shopper has gathered the items that the user has requested, the shopper may perform a checkout process through the shopping cart 100 or client device 120 to charge the user for the items. U.S. Pat. No. 11,195,222, entitled “Determining Recommended Items for a Shopping List,” issued Dec. 7, 2021, describes online systems in more detail, which is incorporated by reference herein in its entirety.

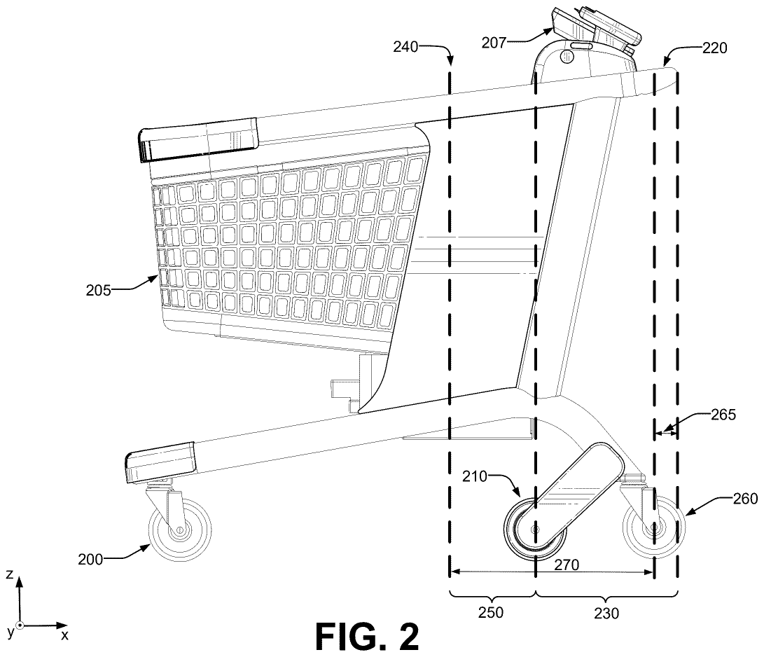

FIG. 2 is a first side view of an example embodiment of a smart shopping cart with a forward-positioned rear wheel, in accordance with one or more embodiments. The smart shopping cart includes a shopping basket 205 for receiving and storing shopping items. The shopping basket 205 may include one or more sensors (e.g., the one or more load sensors 170) placed within the shopping basket for sensing items placed inside the shopping basket 205. The smart shopping cart further includes one or more computational components 207 positioned near a rear portion of the smart shopping cart. The one or more computational components 207 are in communication with the one or more sensors in the shopping basket 205 and control operations of a display and a battery of the smart shopping cart.

The smart shopping cart includes a pair of front wheels 200 and a pair of forward-positioned rear wheels 210 (“rear wheels”). The front wheels 200 are swivel wheels and the rear wheels 210 are fixed (e.g., directional) wheels. The rear wheels 210 are forward positioned in that the rear wheels 210 are positioned more than a predetermined distance (e.g., between 240 mm and 300 mm) in front of handlebars 220 of the smart shopping cart. Whereas the rear wheels of traditional shopping carts are generally close to or toward the rear of the handlebars of the shopping cart, the rear wheels 210 of the described smart shopping cart are substantially in front of the handlebars 220. The rear wheels 210 may operate as the load-bearing wheels. In one or more embodiments, an odometer (not shown in FIG. 2) is added to at least one of the rear wheels 210.

Each rear wheel 210 is located between a center of mass 240 of the smart shopping cart and the handlebars 220 along the x axis (e.g., horizontal axis, or axis of the shopping cart). By moving the rear wheels 210 closer to the center of mass 240, the torque (i.e., rotating or turning force) applied from the handlebars 220 is extended and the described smart shopping cart becomes easier to turn relative to traditional shopping carts and/or other smart shopping carts. In one or more embodiments, a first distance from a center of each rear wheel 210 to the center of the mass 240 along the x axis is less than a second distance from the center of each rear wheel 210 to the handlebars 220 along the x axis. For example, a distance 250 from the center of each rear wheel 210 to the center of mass 240 may be 150 mm to 210 mm, and preferably 180 mm; and a distance 230 from the center of each rear wheel 210 to the handlebars 220 may be 240 mm to 300 mm, and preferably 270 mm. In one or more other embodiments, a first distance from the center of each rear wheel 210 to the center of mass 240 along the x axis is greater than a second distance from the center of each rear wheel 210 to the handlebars 220 along the x axis. The center of each rear wheel 210 is located within a predetermined distance (i.e., in a vicinity) of a midpoint between the center of mass 240 and the handlebars 220 along the x axis. The center of mass 240 may be closer to the rear of the smart shopping cart than to the midpoint of the smart shopping cart.

In the illustrated embodiments, the smart shopping cart includes a pair of support wheels 260. The support wheels 260 are located closer to the handlebars 220 than the rear wheels 210. Thus, a distance 265 from a center of each support wheel 260 to the handlebars 220 along the x axis is less than the distance 230 from the center of each rear wheel 210 to the handlebars 220 along the x axis. Additionally, a distance 270 from the center of each support wheel 260 to the center of mass 240 along the x axis is greater than the distance 250 from the center of each rear wheel 210 to the center of mass 240 along the x axis. Since the rear wheels 210 are located closer to the center of mass 240 of the smart shopping cart than in traditional shopping carts, there is an increased likelihood that the smart shopping cart could tip backwards if a user leans on the handlebar 220. The support wheels 260 serve to stop the described smart shopping cart from tipping in the event that the smart shopping cart starts to tip. Thus, the support wheels 260 are safety wheels, i.e., instead of having a maneuvering function, the support wheels 260 have a safety function.

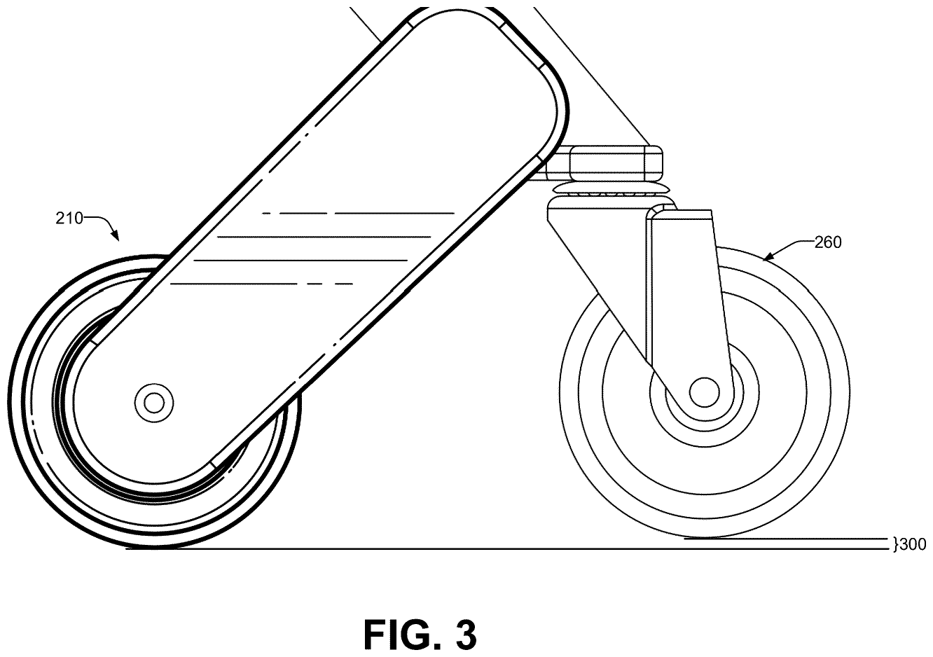

In the illustrated embodiment, the support wheels 260 are positioned such that the support wheels 260 are raised above the ground relative to the front wheels 200 and the rear wheels 210. FIG. 3 is a zoomed-in view of the wheels of the smart shopping cart, in accordance with one or more embodiments. As illustrated in FIG. 3, a distance 300 is a separation distance between the support wheel 260 and the ground. For example, the support wheels 260 are lifted approximately between 3 mm and 7 mm from the ground, i.e., the distance 300 is approximately between 3 mm and 7 mm. The support wheels 260 with off the ground design prevent the possibility of flipping the smart shopping cart. The support wheels 260 may further prevent the rear wheels 210 from being off the ground due to deformation, increasing stability of the smart shopping cart. In one or more alternative embodiments, the support wheels 260 are level with the front wheels 200 and the rear wheels 210. Similarly, the support wheels 260 may be swiveled or fixed (e.g., directional). Furthermore, other mechanisms may be used for stopping the smart shopping cart from tipping backwards, such as a bar or leg without a wheel. Such a bar or leg may be covered with a soft or rubbery material to induce friction and minimize (or at least reduce) impacts by users with the bar or the leg. The bar or the lag may be located closer to the handlebars 220 than the pair of rear wheels 210, wherein the bar or the lag is lifted from the ground when the pair of front wheels 200 and the pair of rear wheels 210 touch the ground.

As aforementioned, by moving the rear wheels 210 closer to the center of mass 240 of the smart shopping cart, the turning force (i.e., torque) is reduced. According to the calculation formula of the torque balance law and Newton's third law (action and reaction force), the following can be derived. For example, if the center of the rear wheel 210 is 410 mm from the center of mass 240 and the center of the front wheel 200 is 515 mm from the center of mass 240, then f1*410 mm=f2*515 mm, where f1 is the weight force (i.e., force of gravity) exerted on the rear wheel 210, and f2 is the weight force (i.e., force of gravity) exerted on the front wheel 200. For f1+f2=500 (N), f1=278.4 N and f2=222.6 N. Then, the resistance of the rear wheel 210 is F1=K*139.2 N, and the resistance of each front wheel 200 is F2=F3=K*111.3 N, where K is the friction coefficient.

When the rear wheel 210 moves closer to the center of mass 240 by 150 mm (i.e., the center of the rear wheel 210 is 260 mm from the center of mass 240), then f1*260=f2*515. For f1+f2=500 (N), f1=333.2 N and f2=167.8 N. Then, the resistance of the rear wheel 210 is F1=K*166.1 N, and the resistance of each front wheel 200 is F2=F3=K*83.9 N. Thus, by moving the rear wheel 210 closer to the center of mass 240 by 150 mm, the resistance of each front wheel 200 is reduced from K*111.3 N to K*83.9 N, i.e., by approximately 24.62%.

When turning the smart shopping cart, the fulcrum is one of the rear wheels 210 depending on which side the smart shopping cart is being turned, whereas the front wheels 200 and the handlebars 220 are the leverage. The resistance torque for turning the smart shopping cart is F1*L1+F2*L2+F3*L3, where F1 is a drag force applied to one of the rear wheels 210 that is not the fulcrum, L1 is a distance between the rear wheels 210, L2 is a distance between the rear wheel 210 representing the fulcrum and the front wheel 200 that is diagonally positioned from the fulcrum, F2 is a drag force applied to the diagonally positioned front wheel, L3 is a distance between the rear wheel 210 representing the fulcrum and the front wheel 200 that is positioned on the same side of the smart shopping cart as the fulcrum, and F3 is a drag force applied to the front wheel 200 that is on the same side as the fulcrum. When the rear wheel 210 moves forward and turns, F1 increases, L1 remains unchanged, F2 decreases, L2 decreases, F3 decreases, and L3 decreases. As a result, the final total value of the resistance torque for turning the smart shopping cart decreases.

There is one driving force for turning the smart shopping cart, which is the unilateral thrust force of the handlebars 220. The torque value of the unilateral thrust force is F4*L4, where F4 is the unilateral thrust force of the handlebars 220, and L4 is a distance between a position on the handlebars 220 where the unilateral thrust force is applied and the rear wheel 210 representing the fulcrum. When torque value of the unilateral thrust force of the handlebars 220 is larger than the resistance torque for turning the smart shopping cart, i.e., when F4*L4>F1*L1+F2*L2+F3*L3, the shopping cart turns and starts moving successfully. As the total resistance torque decreases when turning the smart shopping cart, when L4 remains unchanged, the required thrust force F4 for starting the smart shopping cart also decreases accordingly.

Comparing to the conventional shopping cart with the volume of 180 L, the turning force (i.e., torque) of the smart shopping cart presented herein of the same volume is decreased on average by approximately 4.74%, which makes the smart shopping cart presented herein easier to turn relative to the conventional shopping cart. Table I shows comparative results with respect to turning forces for different item weights included in the conventional shopping cart and the smart shopping cart presented herein.

TABLE I

| | | | |
|---|---|---|---|
| | Conventional | Smart Shopping | Compared to |
| Item | Cart 180 L | Cart (FIG. 2) | Conventional |
| Weight | Torque (Nm) | Torque (Nm) | Cart |

| | | | | |
|---|---|---|---|---|
| 0 | kg | 8.25 | 9.07 | −9.94% |
| 5 | kg | 10.51 | 9.79 | 6.85% |
| 10 | kg | 12.28 | 11.13 | 9.36% |
| 15 | kg | 13.26 | 12.25 | 7.62% |
| 20 | kg | 14.48 | 14.17 | 2.14% |
| 25 | kg | 16.83 | 14.74 | 12.42% |
| | | | Average | 4.74% |
| | | | improvement | |

Additionally, the smart shopping cart presented herein shows a higher starting pushing force compared to the conventional shopping cart. Hence, the presented smart shopping cart more easily overcomes the static friction than the conventional shopping cart. Table II shows the starting pushing force and the straight-forward pushing force comparative results when different loading weights are applied to the conventional shopping cart and the smart shopping cart in FIG. 2.

TABLE II

| Starting | Conventional | Smart Shopping | Compared to |
|---|---|---|---|
| Pushing | Cart Pushing | Cart (FIG. 2) | Conventional |
| Force (N) | Force (N) | Pushing Force (N) | Cart |
| 0 kg | 3.7 | 6.5 | 77.05% |
| 10 kg | 5.0 | 8.5 | 70.68% |
| 20 kg | 5.7 | 10.0 | 75.35% |
| 40 kg | 7.6 | 11.1 | 46.30% |

| Straight | Conventional | Smart Shopping | Compared to |
|---|---|---|---|
| Forward Pushing | Cart Pushing | Cart (FIG. 2) | Conventional |
| Force (N) | Force (N) | Pushing Force (N) | cart |
| 0 kg | 2.8 | 5.0 | 78.66% |
| 10 kg | 3.7 | 6.1 | 65.55% |
| 20 kg | 4.7 | 7.0 | 49.04% |
| 40 kg | 6.6 | 8.8 | 33.49% |

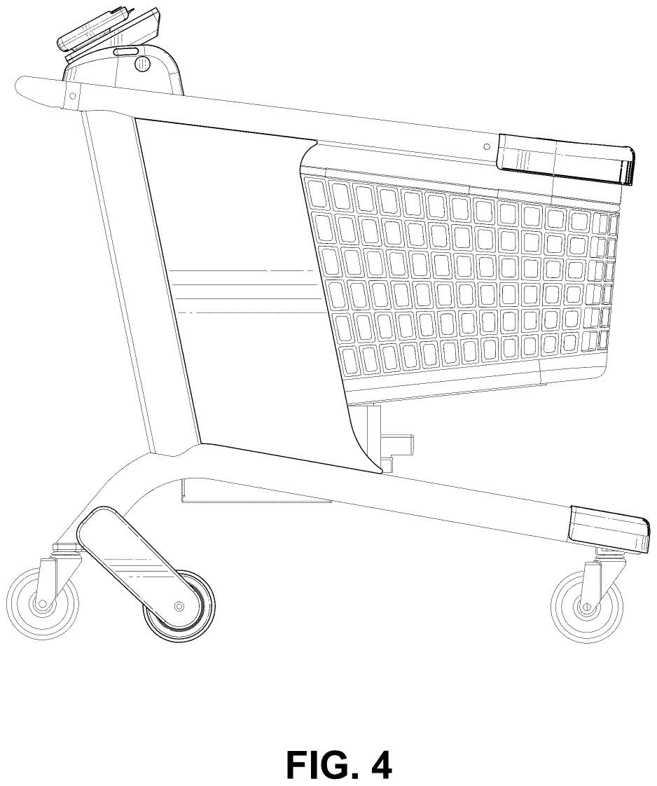

FIG. 4 is a second side view of an example embodiment of a smart shopping cart with a forward-positioned rear wheel, in accordance with one or more embodiments.

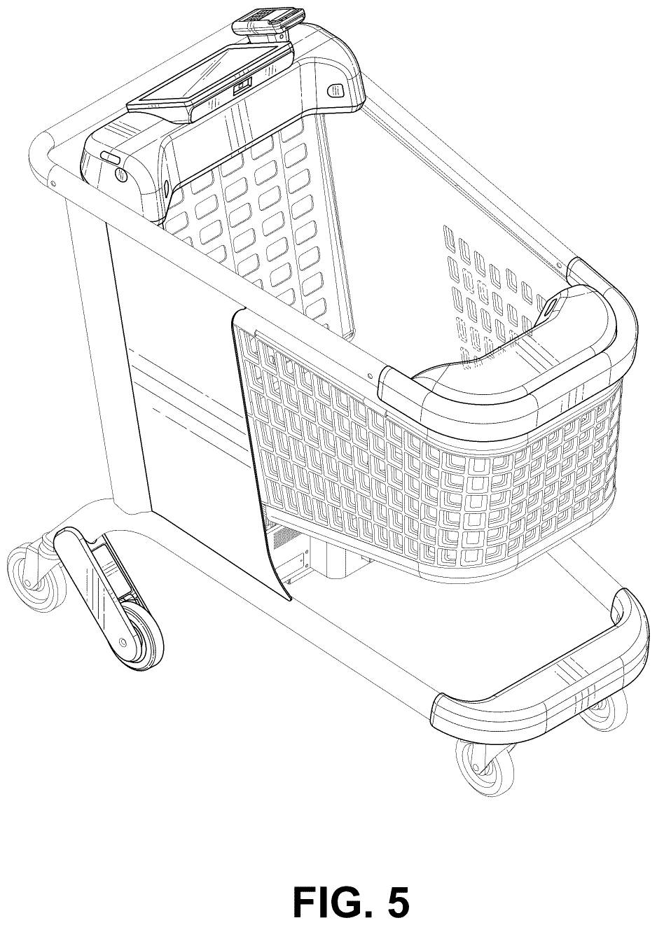

FIG. 5 is a first perspective view of an example embodiment of a smart shopping cart with a forward-positioned rear wheel, in accordance with one or more embodiments.

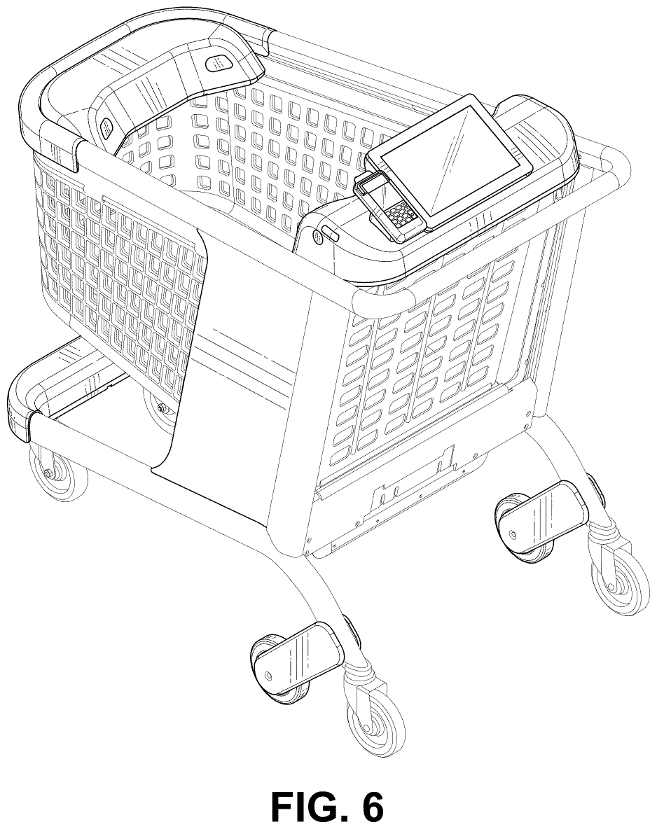

FIG. 6 is a second perspective view of an example embodiment of a smart shopping cart with a forward-positioned rear wheel, in accordance with one or more embodiments.

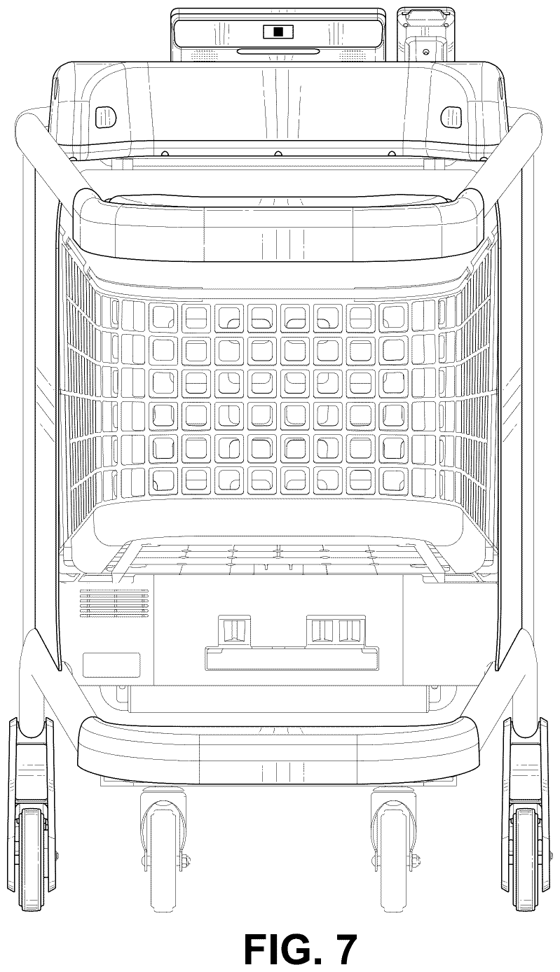

FIG. 7 is a front view of an example embodiment of a smart shopping cart with a forward-positioned rear wheel, in accordance with one or more embodiments.

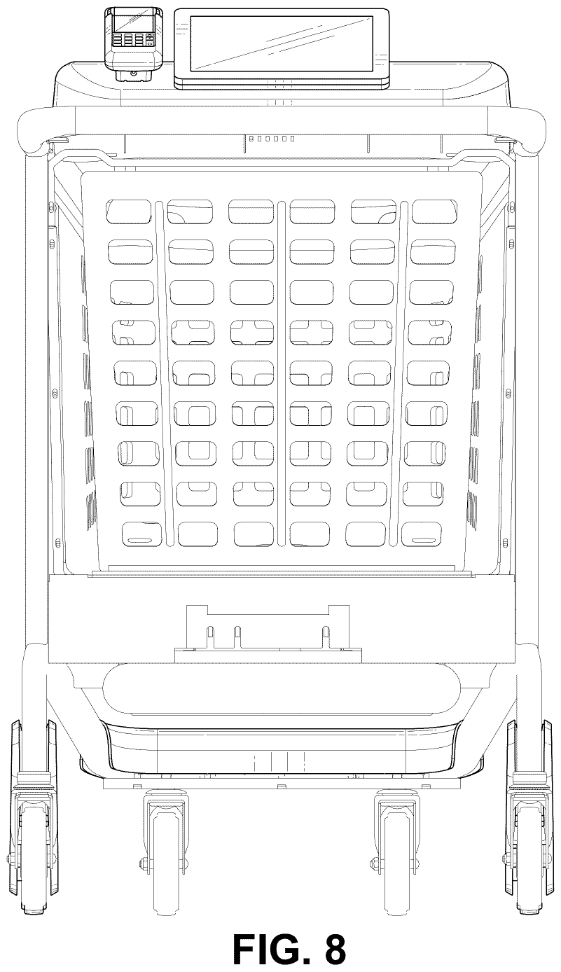

FIG. 8 is a rear view of an example embodiment of a smart shopping cart with a forward-positioned rear wheel, in accordance with one or more embodiments.

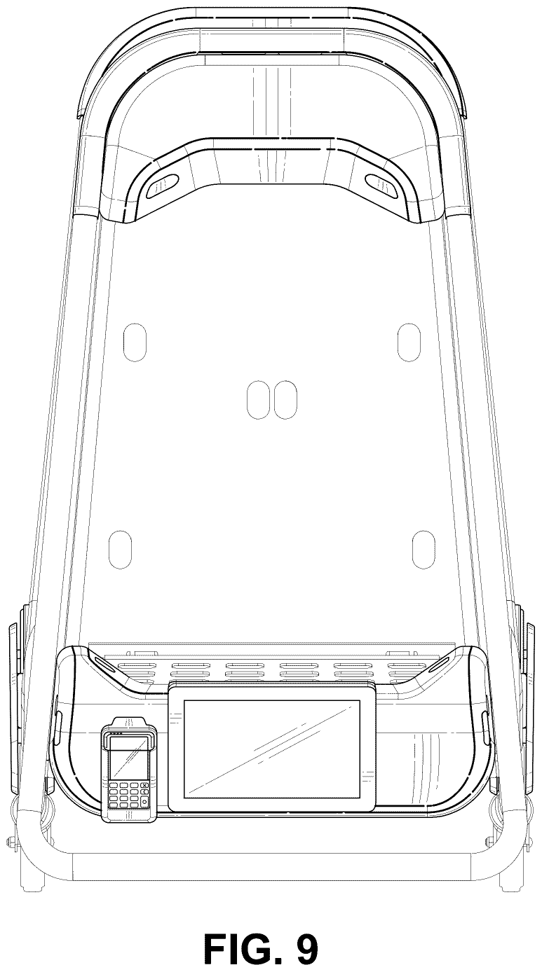

FIG. 9 is a top-down view of an example embodiment of a smart shopping cart with a forward-positioned rear wheel, in accordance with one or more embodiments.

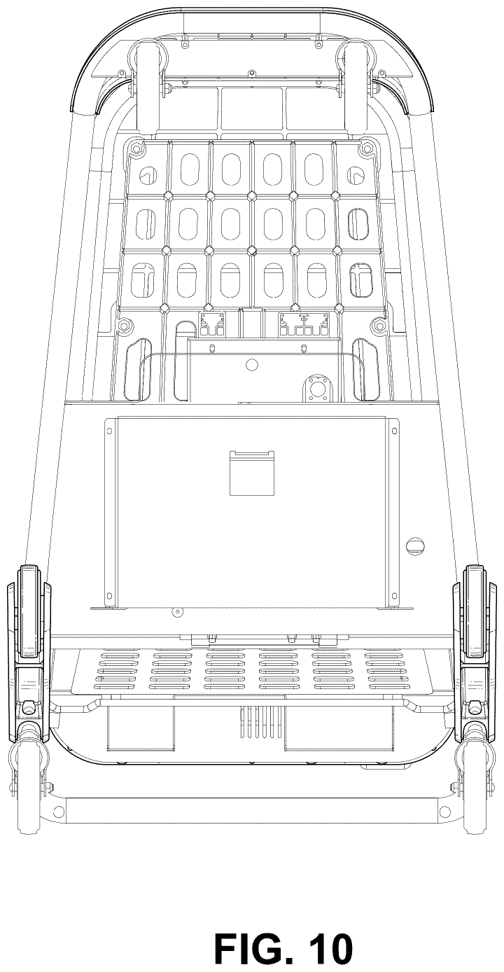

FIG. 10 is a bottom-up view of an example embodiment of a smart shopping cart with a forward-positioned rear wheel, in accordance with one or more embodiments.

### OTHER CONSIDERATIONS

The foregoing description of the embodiments has been presented for the purpose of illustration; it is not intended to be exhaustive or to limit the scope of the disclosure. Many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In some embodiments, a software module is implemented with a computer program product comprising one or more computer-readable media containing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to an apparatus for performing the operations herein. This apparatus may be specially constructed for the required purposes, or it may comprise a computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

The description herein may describe processes and systems that use machine-learning models in the performance of their described functionalities. A “machine-learning model,” as used herein, comprises one or more machine-learning models that perform the described functionality. Machine-learning models may be stored on one or more computer-readable media with a set of weights. These weights are parameters used by the machine-learning model to transform input data received by the model into output data. The weights may be generated through a training process, whereby the machine-learning model is trained based on a set of training examples and labels associated with the training examples. The weights may be stored on one or more computer-readable media, and are used by a system when applying the machine-learning model to new data.

The language used in the specification has been principally selected for readability and instructional purposes, and it may not have been selected to delineate or circumscribe the inventive subject matter. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or.” For example, a condition “A or B” is satisfied by any one of the following: A is true (or present) and B is false (or not present), A is false (or not present) and B is true (or present), and both A and B are true (or present). Similarly, a condition “A, B, or C” is satisfied by any combination of A, B, and C having at least one element in the combination that is true (or present). As a not-limiting example, the condition “A, B, or C” is satisfied by A and B are true (or present) and C is false (or not present). Similarly, as another not-limiting example, the condition “A, B, or C” is satisfied by A is true (or present) and B and C are false (or not present).

What is claimed is:

1. A smart shopping cart comprising:
a basket for storing items, the basket including one or more sensors;
one or more computational components in communication with the one or more sensors;
a pair of front wheels configured to swivel; and
a pair of rear wheels positioned more than a predetermined distance in front of handlebars of the smart shopping cart, each rear wheel of the pair of rear wheels located between a center of a mass of the smart shopping cart and the handlebars along an axis of the smart shopping cart, wherein the pair of rear wheels are fixed wheels.

2. The smart shopping cart of claim 1, wherein a first distance from a center of each rear wheel of the pair of rear wheels to the center of the mass of the smart shopping cart along the axis is less than a second distance from the center of each rear wheel to the handlebars along the axis.

3. The smart shopping cart of claim 1, wherein a first distance from a center of each rear wheel of the pair of rear wheels to the center of the mass of the smart shopping cart along the axis is greater than a second distance from the center of each rear wheel to the handlebars along the axis.

4. The smart shopping cart of claim 1, wherein a center of each rear wheel of the pair of rear wheels is located within a second predetermined distance of a midpoint between the center of the mass of the smart shopping cart and the handlebars along the axis.

5. The smart shopping cart of claim 1, wherein a distance from a center of each rear wheel of the pair of rear wheels to the handlebars is between 240 mm and 300 mm.

6. The smart shopping cart of claim 1, wherein a distance from a center of each rear wheel of the pair of rear wheels to the center of the mass of the smart shopping cart is between 150 mm and 210 mm.

7. The smart shopping cart of claim 1, further comprising:
a pair of support wheels, wherein a first distance from a center of each support wheel of the pair of support wheels to the center of the mass of the smart shopping cart along the axis is greater than a second distance from the center of each rear wheel to the center of the mass along the axis.

8. The smart shopping cart of claim 7, wherein a third distance from the center of each support wheel to the handlebars along the axis is less than a fourth distance from the center of each rear wheel to the handlebars along the axis.

9. The smart shopping cart of claim 7, wherein the pair of support wheels are lifted from a ground when the pair of front wheels and the pair of rear wheels touch the ground.

10. The smart shopping cart of claim 7, wherein each support wheel of the pair of support wheels is lifted approximately between 3 mm and 7 mm from a ground when the pair of front wheels and the pair of rear wheels touch the ground.

11. The smart shopping cart of claim 7, wherein the pair of support wheels are positioned at a same level relative to a ground as the pair of front wheels and the pair of rear wheels.

12. The smart shopping cart of claim 7, wherein the pair of support wheels are configured to swivel.

13. The smart shopping cart of claim 7, wherein the pair of support wheels are fixed wheels.

14. The smart shopping cart of claim 1, further comprising:
a bar located closer to the handlebars along the axis than the pair of rear wheels, wherein the bar is located further from the center of the mass of the smart shopping cart along the axis than the pair of rear wheels.

15. The smart shopping cart of claim 14, wherein the bar is lifted from a ground when the pair of front wheels and the pair of rear wheels touch the ground.

16. The smart shopping cart of claim 1, further comprising:
a leg located closer to the handlebars along the axis than the pair of rear wheels, wherein the leg is lifted from a ground when the pair of front wheels and the pair of rear wheels touch the ground.

17. A smart shopping cart comprising:
a pair of front wheels configured to swivel; and
a pair of rear wheels positioned substantially in front of handlebars of the smart shopping cart, each rear wheel of the pair of rear wheels located between a center of a mass of the smart shopping cart and the handlebars along an axis of the smart shopping cart, wherein the pair of rear wheels are fixed wheels.

18. The smart shopping cart of claim 17, wherein a first distance from a center of each rear wheel of the pair of rear wheels to the center of the mass of the smart shopping cart along the axis is less than a second distance from the center of each rear wheel to the handlebars along the axis.

19. The smart shopping cart of claim 17, wherein:
a first distance from a center of each rear wheel of the pair of rear wheels to the handlebars along the axis is between 240 mm and 300 mm; and
a second distance from the center of each rear wheel to the center of the mass of the smart shopping cart along the axis is between 150 mm and 210 mm.

20. The smart shopping cart of claim 17, further comprising:
a pair of support wheels, wherein a first distance from a center of each support wheel of the pair of support wheels to the center of the mass of the smart shopping cart along the axis is greater than a second distance from the center of each rear wheel to the center of the mass along the axis.
